(19) United States
(12) Patent Application Publication
(10) Pub. No.: US 2026/0336090 A1
(43) Pub. Date: Oct. 29, 2026

(54) WORKING MACHINE

(71) Applicant: Makita Corporation, Anjo-shi (JP)

(72) Inventors: Shusuke ITO, Anjo-shi (JP); Yoichi Ito, Anjo-shi (JP)

(73) Assignee: Makita Corporation, Anjo-shi (JP)

(21) Appl. No.: 19/650,749

(22) Filed: Apr. 17, 2026

(30) Foreign Application Priority Data
Apr. 23, 2025 (JP) 2025-071272

(51) Int. Cl. B25F 5/00; H02K 5/18; H02K 5/20; H02K 7/102; H02K 7/14; H02K 9/06; H02K 9/26; H02K 11/33; H02K 21/16; B23D 57/02

(52) U.S. Cl. CPC B25F 5/008; H02K 5/18; H02K 5/207; H02K 7/102; H02K 7/145; H02K 9/06; H02K 9/26; H02K 11/33; H02K 21/16; B23D 57/023; H02K 2211/03

(57) ABSTRACT

A working machine may include: a working part; an electric motor; a control device; a housing; an inlet; an outlet; a cooling air passage; and a fan configured to generate cooling air which flows from the inlet through the cooling air passage to the outlet. The control device may include a first surface and a second surface. The cooling air passage may include a first passage portion facing the first surface and a second passage portion facing the second surface. The cooling air may flow through the first passage portion and then the second passage portion. A flow rate of the cooling air flowing through the first passage portion and a flow rate of the cooling air flowing through the second passage portion may be substantially equal to each other.

### SPECIFICATION

### CROSS REFERENCE TO RELATED APPLICATION

This application claims priority to Japanese Patent Application No. 2025-071272 filed on Apr. 23, 2025. The entire content of the priority application is incorporated herein by reference.

### TECHNICAL FIELD

The art disclosed herein relates to a working machine.

### BACKGROUND ART

Japanese Patent Application Publication No. 2018-085970 describes a working machine which includes: a working part; an electric motor configured to drive the working part; a control device configured to control the electric motor; a housing that houses the electric motor and the control device; an inlet communicating an interior and an exterior of the housing with each other; an outlet communicating the interior and the exterior of the housing with each other; a cooling air passage defined in the interior of the housing and configured to send air, which flowed in through the inlet, toward the outlet; and a fan configured to generate cooling air which flows from the inlet through the cooling air passage to the outlet. The control device includes a first surface and a second surface that are in a front-and-back relationship with each other. The cooling air passage includes a first passage portion facing the first surface of the control device and a second passage portion facing the second surface of the control device. The first passage portion and the second passage portion are connected in parallel to each other. A part of the cooling air flows through the first passage portion and the remainder thereof flows through the second passage portion.

### SUMMARY

In the working machine of Japanese Patent Application Publication No. 2018-085970, the two side surfaces of the control device (i.e., the first surface and the second surface) are cooled by the cooling air flowing through each of the first passage portion and the second passage portion. However, since the first passage portion and the second passage portion are connected in parallel with each other, when the flow rate of cooling air flowing through the first passage portion (i.e., a first flow rate) increases, the flow rate of cooling air flowing through the second passage portion (i.e., a second flow rate) decreases accordingly. Conversely, as the second flow rate increases, the first flow rate decreases accordingly. Thus, there is a trade-off between the first and second flow rates, and it is difficult to increase both the first and second flow rates. As a result, the control device may not be sufficiently cooled. This specification provides a technique configured to sufficiently cool the control device.

A working machine may comprise: a working part; an electric motor configured to drive the working part; a control device configured to control the electric motor; a housing that houses the electric motor and the control device; an inlet communicating an interior and an exterior of the housing with each other; an outlet communicating the interior and the exterior of the housing with each other; a cooling air passage defined in the interior of the housing and configured to send air, which flowed in through the inlet, toward the outlet; and a fan configured to generate cooling air which flows from the inlet through the cooling air passage to the outlet. The control device may comprise a first surface and a second surface that are in a front-and-back relationship with each other. The cooling air passage may comprise a first passage portion facing the first surface of the control device and a second passage portion facing the second surface of the control device. The first passage portion and the second passage portion may be connected in series with each other. The cooling air may flow through the first passage portion and then the second passage portion. A flow rate of the cooling air flowing through the first passage portion and a flow rate of the cooling air flowing through the second passage portion may be substantially equal to each other.

### BRIEF DESCRIPTION OF DRAWINGS

FIG. 1 is a view of a chainsaw 2 according to an embodiment viewed from a front upper right side.

FIG. 2 is a view of the chainsaw 2 of the embodiment viewed from a right side.

FIG. 3 is a view of an internal structure of the chainsaw 2 of the embodiment viewed from a left side.

FIG. 4 is a view of a sprocket cover 10 of the chainsaw 2 of the embodiment and its surroundings, viewed from the front upper right side.

FIG. 5 is a view of a sprocket 16 of the chainsaw 2 of the embodiment and its surroundings viewed from the front upper right side.

FIG. 6 is a view of a front grip 36, a tool 72, and a retainer 80 of the chainsaw 2 of the embodiment.

FIG. 7 is a view of the tool 72 and the retainer 80 of the chainsaw 2 of the embodiment, viewed in a cross-section perpendicular to a left-right direction.

FIG. 8 is a view of a plurality of inlets 100 and surroundings thereof of the chainsaw 2 of the embodiment, viewed from a rear upper left side.

FIG. 9 is a view of a filter 102 and its surroundings of the chainsaw 2 of the embodiment, viewed from the rear upper left side.

FIG. 10 is a view of the filter 102 of the chainsaw 2 of the embodiment viewed from a rear upper right side.

FIG. 11 is a view of a lower surface of a body 18 of the chainsaw 2 of the embodiment, viewed from a front lower left side.

FIG. 12 is a view of a cooling air passage 190 of the chainsaw 2 of the embodiment, viewed in a cross-section perpendicular to a front-rear direction.

FIG. 13 is a view of a control device 120 of the embodiment viewed from an upper side.

FIG. 14 is a cross-sectional perspective view of an upper passage portion 190a of the cooling air passage 190 of the chainsaw 2 of the embodiment.

FIG. 15 is a view of the control device 120 of the embodiment viewed from a lower side.

FIG. 16 shows how a depth limiter 200 of the embodiment is attached to and detached from a guide bar 6.

FIG. 17 shows how the depth limiter 200 of the embodiment is attached to and detached from the guide bar 6.

FIG. 18 shows how the depth limiter 200 of the embodiment is attached to and detached from the guide bar 6.

FIG. 19 shows how the depth limiter 200 of the embodiment is attached to and detached from the guide bar 6.

FIG. 20 shows how the depth limiter 200 of the embodiment is attached to and detached from the guide bar 6.

FIG. 21 is a view of the chainsaw 2 of the embodiment, with a cover 270 attached to the guide bar 6, viewed from the front upper right side.

FIG. 22 is a view of the cover 270 of the embodiment viewed from the front upper right side.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved working machines, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one aspect of the present teachings, a working machine may comprise: a working part; an electric motor configured to drive the working part; a control device configured to control the electric motor; a housing that houses the electric motor and the control device; an inlet communicating an interior and an exterior of the housing with each other; an outlet communicating the interior and the exterior of the housing with each other; a cooling air passage defined in the interior of the housing and configured to send air, which flowed in through the inlet, toward the outlet; and a fan configured to generate cooling air which flows from the inlet through the cooling air passage to the outlet. The control device may comprise a first surface and a second surface that are in a front-and-back relationship with each other. The cooling air passage may comprise a first passage portion facing the first surface of the control device and a second passage portion facing the second surface of the control device. The first passage portion and the second passage portion may be connected in series with each other. The cooling air may flow through the first passage portion and then the second passage portion. A flow rate of the cooling air flowing through the first passage portion and a flow rate of the cooling air flowing through the second passage portion may be substantially equal to each other.

According to the above configuration, since the first passage portion and the second passage portion are connected in series with each other, the flow rate of the cooling air flowing through the first passage portion (i.e., the first flow rate) and the flow rate of the cooling air flowing through the second passage portion (i.e., the second flow rate) are substantially equal. Therefore, since the first flow rate and the second flow rate are not in a trade-off relationship, both the first flow rate and the second flow rate can be increased. This allows the control device to be sufficiently cooled.

In one aspect of the present teachings, the cooling air passage may further comprise a third passage portion passing through an interior of the electric motor. The cooling air may flow through the first passage portion, the second passage portion, and then the third passage portion.

According to the above configuration, the cooling air can cool not only the control device but also the electric motor.

In one aspect of the present teachings, the working machine may further comprise a motor case surrounding an outer peripheral surface of the electric motor. The control device may be disposed such that the second surface faces the motor case.

According to the above configuration, the second passage portion facing the second surface of the control device and the third passage portion passing through the interior of the electric motor are located close to each other. This shortens the cooling air passage and reduces the pressure loss generated when the cooling air flows in the cooling air passage. As a result, it can be suppressed that the pressure loss causes the flow rate of the cooling air to decrease.

In one aspect of the present teachings, the control device may comprise a fin protruding from one of the first surface and the second surface.

According to the above configuration, the presence of the fin can increase a contact area between the control device and the cooling air. This allows the control device to be cooled efficiently.

In one aspect of the present teachings, the one of the first surface and the second surface may comprise a first area in which the fin is disposed and a second area in which the fin is not disposed. The housing may comprise a partition wall partitioning the first area and the second area from each other.

The first area in which the fin is disposed has a higher heat dissipation efficiency than the second area in which the fin is not disposed. According to the above configuration, the partition wall can suppress the cooling air from flowing into the second area (i.e., the area with a relatively low heat dissipation efficiency) and promote the cooling air to flow into the first area (i.e., the area with a relatively high heat dissipation efficiency). This allows a larger flow rate of the cooling air through the first area (i.e., the area with the relatively high heat dissipation efficiency), thus the control device can be cooled more efficiently.

In one aspect of the present teachings, the control device may further comprise a capacitor protruding from the other of the first surface and the second surface.

According to the above configuration, the cooling air flows so that the cooling air is blown onto the outer surface of the capacitor. This allows direct cooling of the capacitor.

In one aspect of the present teachings, the capacitor may comprise a first capacitor and a second capacitor. The first capacitor and the second capacitor may be offset from each other in a direction extending along the other of the first surface and the second surface and perpendicular to a direction in which the cooling air flows.

If the first and second capacitors are aligned along the direction in which the cooling air flows, the capacitor located upstream of the first and second capacitors may become an obstacle and the cooling air may not be blown onto the downstream one of the first and second capacitors. As a result, only one of the first and second capacitors may be cooled, and the other of the first and second capacitors may not be cooled. In contrast, according to the above configuration, the first and second capacitors are aligned in a direction perpendicular to the direction in which the cooling air flows, so the cooling air is blown onto both the first and second capacitors. As a result, both the first and second capacitors can be cooled.

In one aspect of the present teachings, the cooling air passage may comprise an intermediate passage portion facing an end surface of the control device which connects the first surface and the second surface. The cooling air may flow through the first passage portion, the intermediate passage portion, and then the second passage portion.

According to the above configuration, the cooling air flows along three surfaces of the control device (i.e., the first surface, the second surface, and the end surface connecting the first and second surfaces). This allows the control device to be cooled efficiently.

In one aspect of the present teachings, the housing may comprise a flat wall disposed at a connection portion between a downstream end of the intermediate passage portion and an upstream end of the second passage portion, wherein the flat wall extends along the second surface.

According to the above configuration, the flat wall can be used to guide the cooling air flowing from the intermediate passage portion into the second passage portion to flow along the second surface of the control device. This allows the control device to be cooled efficiently.

In one aspect of the present teachings, the first passage portion may extend from one end of the first surface along the first surface to another end of the first surface. The second passage portion may extend from one end of the second surface along the second surface to another end of the second surface.

According to the above configuration, the cooling air flows from one end of the first surface along the first surface to the other end of the first surface, and then from one end of the second surface along the second surface to the other end of the second surface. This allows for a larger contact area between the control device and the cooling air, thus the control device can be cooled efficiently.

In one aspect of the present teachings, the first passage portion may face the inlet.

The cooling air immediately after flowing into the inlet has not yet absorbed any heat from components in the housing, and is at a relatively low temperature. According to the above configuration, the cooling air immediately after flowing into the inlet, i.e., the cooling air with the relatively low temperature, flows through the first passage portion. Therefore, the cooling air dissipates a large quantity of heat from the first surface of the control device. This allows the control device to be cooled efficiently.

In one aspect of the present teachings, the first passage portion may extend along a short-side direction of the first surface of the control device. The second passage portion may extend along a short-side direction of the second surface of the control device.

According to the above configuration, the first passage portion is shorter as compared to a configuration in which the first passage portion extends along a longitudinal direction of the first surface of the control device. Furthermore, according to the above configuration, the second passage portion is shorter as compared to a configuration in which the second passage portion extends along a longitudinal direction of the second face of the control device. These shorten the cooling air passage, thereby reducing the pressure loss generated when the cooling air flows in the cooling air passage. As a result, the pressure loss can be suppressed from causing a decrease in the flow rate of the cooling air.

In one aspect of the present teachings, the working machine may further comprise a filter configured to be detachably attached to the housing so as to cover the inlet from the exterior of the housing.

According to the above configuration, it is possible to suppress foreign object(s) (e.g., cutting debris) from entering the interior of the housing from the exterior through the inlet. Furthermore, according to the above configuration, the user can remove the filter from the housing and clean the filter.

### EMBODIMENT

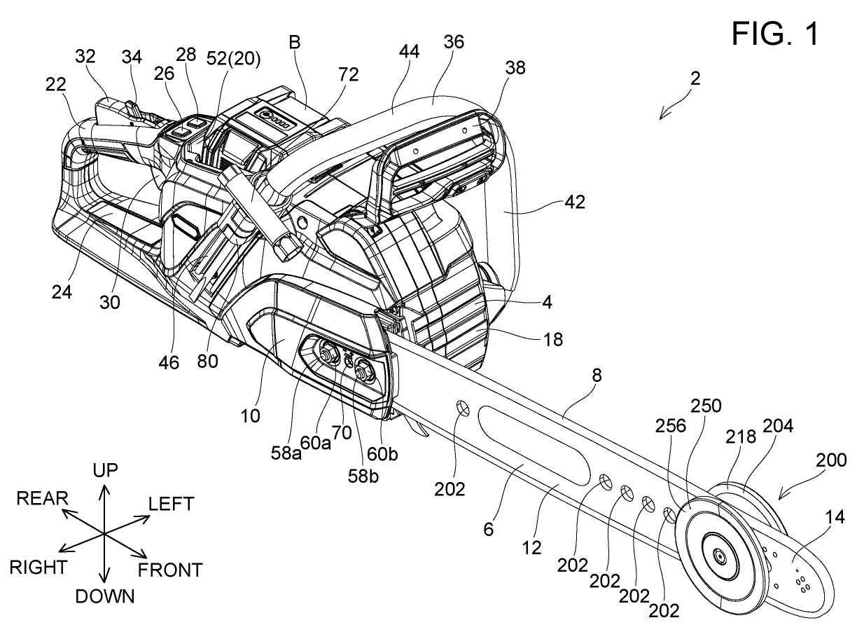

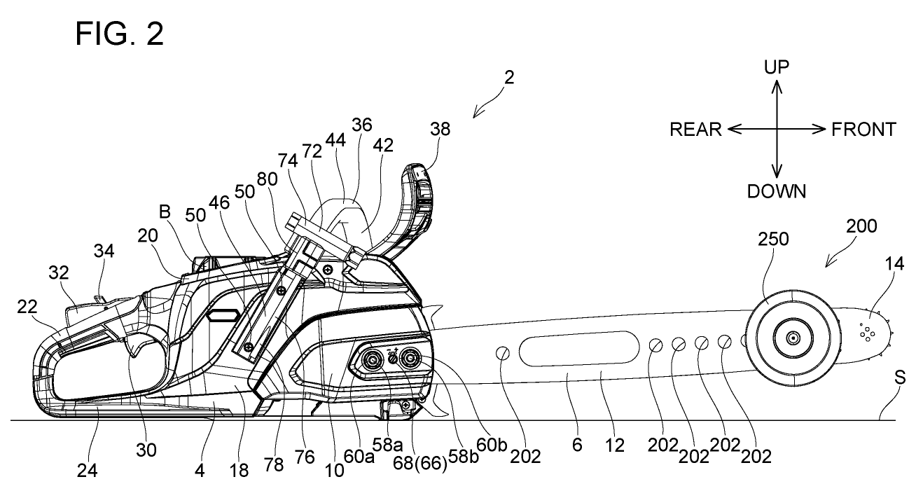

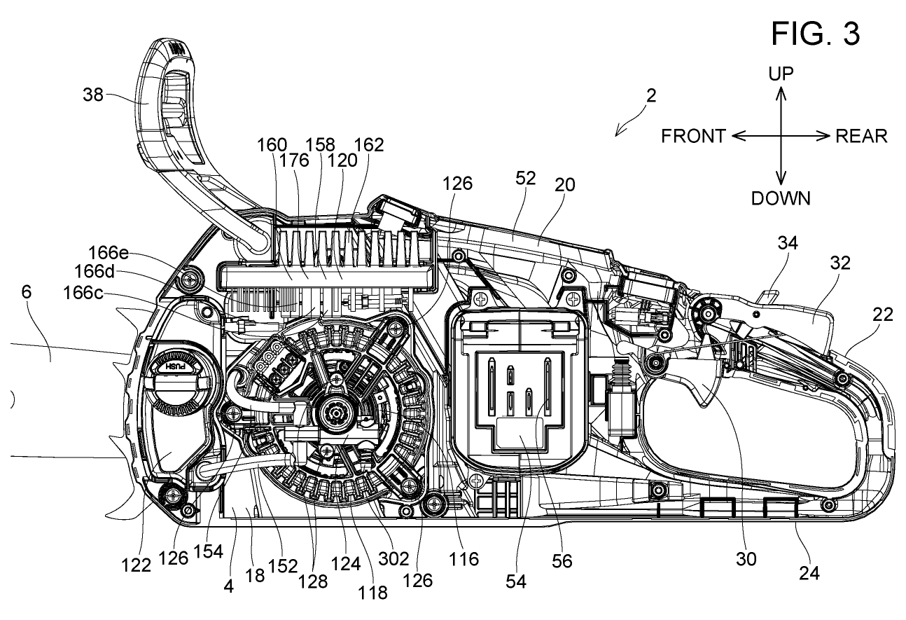

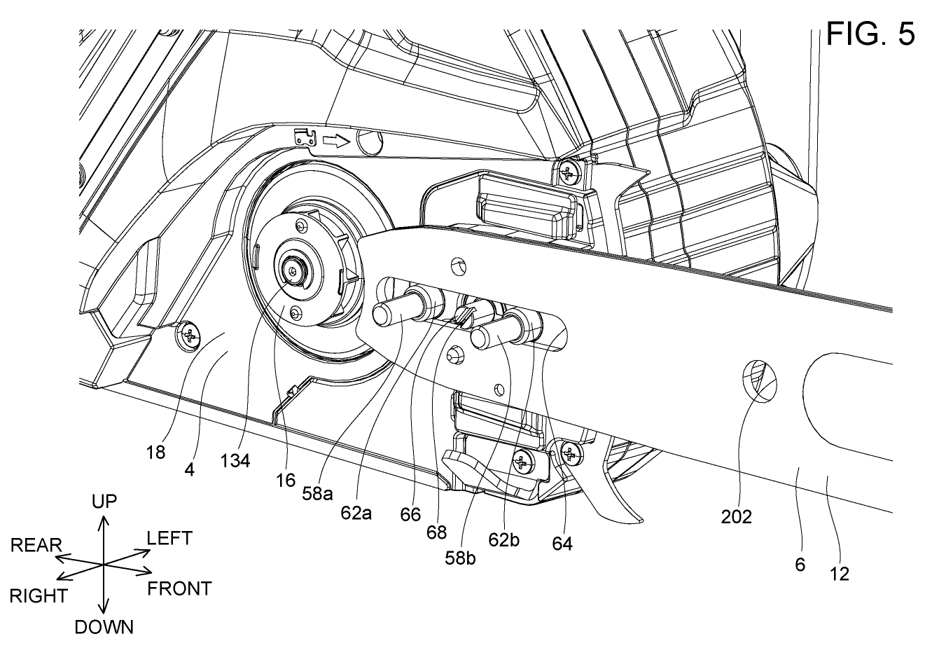

As shown in FIG. 1, a chainsaw 2 comprises a housing 4, a guide bar 6, a saw chain 8, and a sprocket cover 10. The guide bar 6 is an elongated plate-like member attached to the housing 4 so that it protrudes frontward from the housing 4. The guide bar 6 includes a bar body 12 and a tip sprocket 14 disposed at a tip of the bar body 12. The bar body 12 is constituted of a relatively lightweight metal (e.g., aluminum alloy). The tip sprocket 14 is constituted of a relatively high-strength metal (e.g., iron alloy). The saw chain 8 comprises a plurality of interconnected cutters (not shown). The saw chain 8 is mounted along a perimeter of the guide bar 6, with the saw chain 8 engaged with both a sprocket 16 (see FIG. 5) supported by the housing 4 and the tip sprocket 14 of the guide bar 6. The chainsaw 2 is configured to have a battery pack B detachably attached thereto. The battery pack B contains a plurality of rechargeable secondary battery cells (not shown). The chainsaw 2 uses electric power supplied by the battery pack B to operate an electric motor 116 (see FIG. 3), which rotates the sprocket 16 and moves the saw chain 8 along the perimeter of the guide bar 6. The user can cut an object to be cut by pushing the saw chain 8 which is moving along the perimeter of the guide bar 6 against the object to be cut (e.g., window glass, steel plate, roof, door). The chainsaw 2 is used, for example, for rescue work. For simplicity, illustration of the saw chain 8 is omitted from FIG. 2 onward.

In this embodiment, as shown in FIG. 2, the front-rear, up-down, left-right directions are determined based on the chainsaw 2 when the chainsaw 2 is placed on a horizontal resting surface S such as the ground. Specifically, a direction perpendicular to the resting surface S and from the resting surface S to the chainsaw 2 is the upward direction, and the opposite direction is the downward direction. A direction in which the longitudinal direction of the guide bar 6 is projected onto the resting surface S and also the tip of the guide bar 6 is oriented is the frontward direction, and the opposite direction is the rearward direction. A direction perpendicular to the front-rear and up-down directions and in which the outer surface of the sprocket cover 10 faces, is the right direction, and the opposite direction is the left direction.

As shown in FIG. 1, the housing 4 comprises a body 18, a battery housing portion 20, a rear grip 22, and a rear hand guard 24. The body 18 has a substantially rectangular cuboid shape with a longitudinal direction in the front-rear direction.

The rear grip 22 extends from an upper portion of the rear surface of the body 18 in a rear down direction. The rear hand guard 24 extends downward from the rear end of the rear grip 22, then bends to extend frontward, and connects to a lower portion of the rear surface of the body 18. The rear hand guard 24 protects the hand of a user grasping the rear grip 22.

A power button 26 for turning the power of the chainsaw 2 on and off and a speed switch button 28 for switching the speed at which the saw chain 8 moves when the saw chain 8 is driven are disposed on the upper surface near the front end of the rear grip 22. A trigger lever 30 for causing the chainsaw 2 to drive the saw chain 8 is arranged on the lower surface near the front end of the rear grip 22. A main lock lever 32 for locking or unlocking the trigger lever 30 and a sub-lock lever 34 for locking or unlocking the main lock lever 32 are disposed on the upper surface of the rear grip 22. Normally, the main lock lever 32 locks the trigger lever 30 and the sub-lock lever 34 locks the main lock lever 32. That is, the main lock lever 32 and the sub-lock lever 34 prohibit the user from operating the trigger lever 30. When the user tilts the sub-lock lever 34 frontward with the palm of the hand grasping the rear grip 22 from this state, the sub-lock lever 34 unlocks the main lock lever 32. Next, when the user pushes in the main lock lever 32 with the palm of the hand grasping the rear grip 22, the main lock lever 32 unlocks the trigger lever 30. This allows the user to operate the trigger lever 30. When the user pushes in the trigger lever 30 with the index finger of the hand grasping the rear grip 22 from this state, the saw chain 8 is driven.

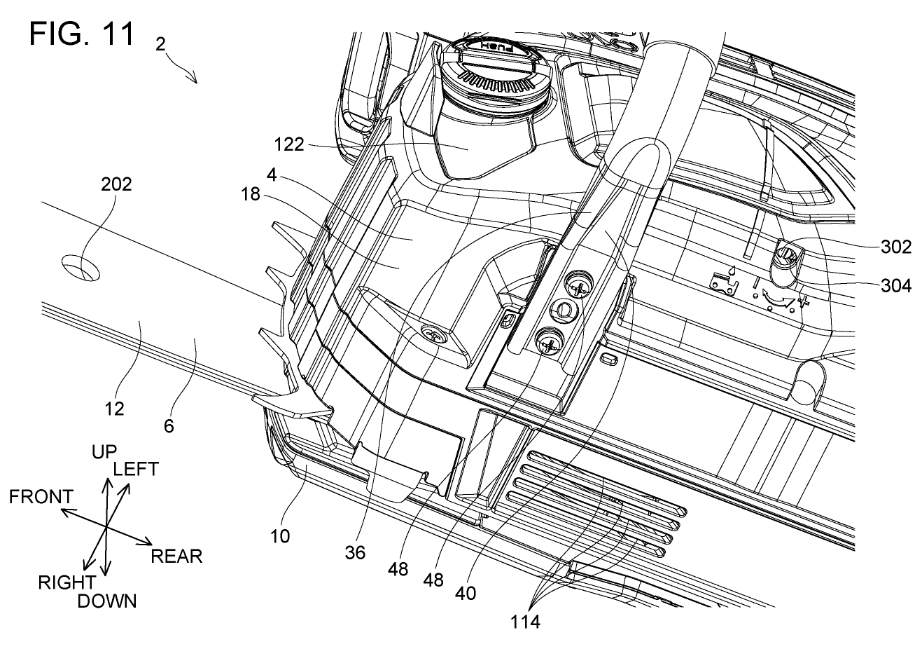

The chainsaw 2 further comprises a front grip 36 and a front hand guard 38. The front grip 36 comprises a lower fixed portion 40 (see FIG. 11) extending in the left-right direction along the lower surface of the housing 4, a left gripping portion 42 extending upward from the left end of the lower fixed portion 40, an upper gripping portion 44 extending rightward from the upper end of the left gripping portion 42, and a right fixed portion 46 extending to a rear and downward direction from the right end of the upper gripping portion 44. The lower fixed portion 40 is fixed to the lower surface of the housing 4 by means of screws 48 (see FIG. 11). The right fixed portion 46 is fixed to a rear portion of the right surface of the housing 4 by screws 50 (see FIG. 2). The user can carry the chainsaw 2 by grasping the left gripping portion 42 or the upper gripping portion 44 of the front grip 36 with one hand and the rear grip 22 with the other hand. The front hand guard 38 is pivotably attached to an upper part of the front portion of the body 18. The front hand guard 38 is configured to pivot about a pivot axis extending in the left-right direction relative to the body 18. The front hand guard 38 is positioned frontward of the front grip 36. The front hand guard 38 protects the hand of a user grasping the upper gripping portion 44 of the front grip 36.

The battery housing portion 20 is disposed between the front grip 36 and the rear grip 22. The battery housing portion 20 has a housing recess 52 formed by recessing a rear part of the upper surface of the body 18 downward, and a battery attaching portion 54 (see FIG. 3) formed on the right wall of the housing recess 52. The user can attach the battery pack B to the battery attaching portion 54 by sliding the battery pack B against the battery attaching portion 54 downward from above. The user can also remove the battery pack B from the battery attaching portion 54 by sliding the battery pack B upward from below against the battery attaching portion 54. With the battery pack B attached to the battery attaching portion 54 (i.e., state shown in FIG. 1), the battery pack B is housed in the housing recess 52.

As shown in FIG. 3, the battery attaching portion 54 has an equipment-side terminal 56 protruding from the right wall of the housing recess 52. When the battery pack B is attached to the battery attaching portion 54, the equipment-side terminal 56 is electrically connected to a battery terminal (not shown) of the battery pack B. The battery terminal is used to charge the battery pack B, discharge the battery pack B, receive signals sent to the battery pack B, and transmit signals from the battery pack B. When the battery pack B is removed from the battery attaching portion 54, the connection between the equipment-side terminal 56 and the battery terminal is disconnected.

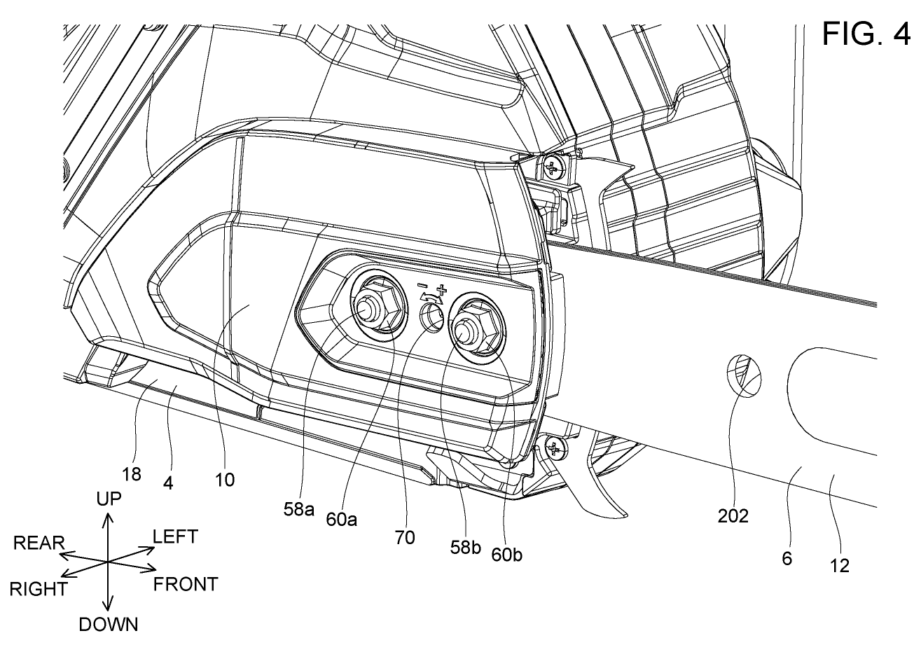

As shown in FIG. 4, the sprocket cover 10, together with the guide bar 6, is fastened to the right surface of the body 18 via bolts 58a, 58b and nuts 60a, 60b. The bolts 58a and 58b are fixed to the body 18 and protrude rightward from the right surface of the body 18. The nuts 60a and 60b are screwed to the bolts 58a and 58b. The sprocket cover 10 and the guide bar 6 are sandwiched between the seating surfaces of the nuts 60a and 60b and the right surface of the body 18. The user can unfasten the sprocket cover 10 and guide bar 6 from the body 18 by removing the nuts 60a and 60b from the bolts 58a and 58b.

As shown in FIG. 5, the sprocket 16 is exposed to a space inside the sprocket cover 10 (see FIG. 4) and outside the body 18. The guide bar 6 has a long hole 64 extending along the front-rear direction. Support pins 62a and 62b defined near the base ends of bolts 58a and 58b are fitted into the long hole 64. The guide bar 6 is supported by the body 18 via the support pins 62a, 62b. The user can adjust the tension of the saw chain 8 (see FIG. 1) by sliding the guide bar 6 in the front-rear direction against the body 18 with the nuts 60a and 60b loosened relative to the bolts 58a and 58b, thereby changing a distance between the guide bar 6 and the sprocket 16 in the front-rear direction. A position adjustment screw 66 is arranged between the support pins 62a and 62b. The position adjustment screw 66 has a slotted recess 68 in which a flathead screwdriver can be engaged. By tightening or loosening the position adjustment screw 66, the user can move the guide bar 6 in the front-rear direction and adjust the tension of the saw chain 8. As shown in FIG. 4, the sprocket cover 10 has an exposing hole 70 that exposes the position adjustment screw 66 to the outside. This allows the user to tighten or loosen the position adjustment screw 66 with the sprocket cover 10 remaining attached to the body 18.

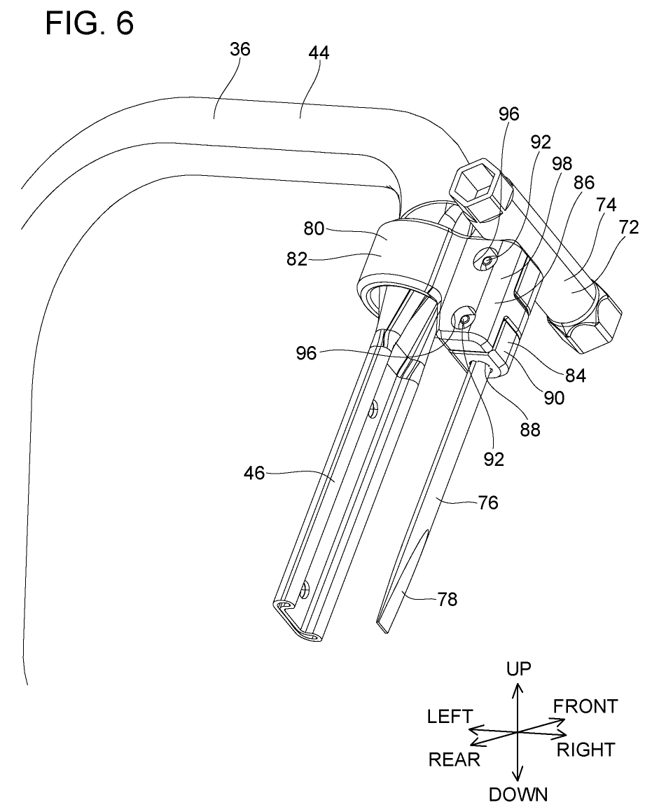

As shown in FIG. 6, a retainer 80 configured to retain a tool 72 is attached to the front grip 36 (specifically, the upper part of the right fixed portion 46). The tool 72 in this embodiment can be used to tighten or loosen the nuts 60a and 60b (see FIG. 4) relative to the bolts 58a and 58b (see FIG. 5) or to make adjustments via the position adjustment screw 66 (see FIG. 5). Specifically, the tool 72 comprises a wrench portion 74 that fits on the outer surfaces of the nuts 60a and 60b, a rod portion 76 that extends from the outer peripheral surface of the wrench portion 74, and a flathead screwdriver portion 78 defined on the tip of the rod portion 76. The user can use the wrench portion 74 of the tool 72 to tighten or loosen the nuts 60a and 60b relative to the bolts 58a and 58b. The user can use the flathead screwdriver portion 78 of the tool 72 to tighten or loosen the position adjustment screw 66. The user can also tighten or loosen an oil volume adjustment screw 302 (see FIG. 3) on an oil pump 124 using the flathead screwdriver portion 78 of the tool 72. By tightening or loosening the oil volume adjustment screw 302, the amount of lubricating oil supplied by the oil pump 124 from an oil tank 122 to the guide bar 6 and saw chain 8 when the saw chain 8 is driven can be adjusted. As shown in FIG. 11, the oil volume adjustment screw 302 is exposed to the outside of the housing 4 through an exposing hole 304 defined on the lower surface of the housing 4.

A flexible material (e.g., rubber material) is used for the retainer 80 shown in FIG. 6. The retainer 80 has a band portion 82 that is wrapped around the right fixed portion 46, a first retaining portion 84 connected to one end of the band portion 82, and a second retaining portion 86 connected to the other end of the band portion 82.

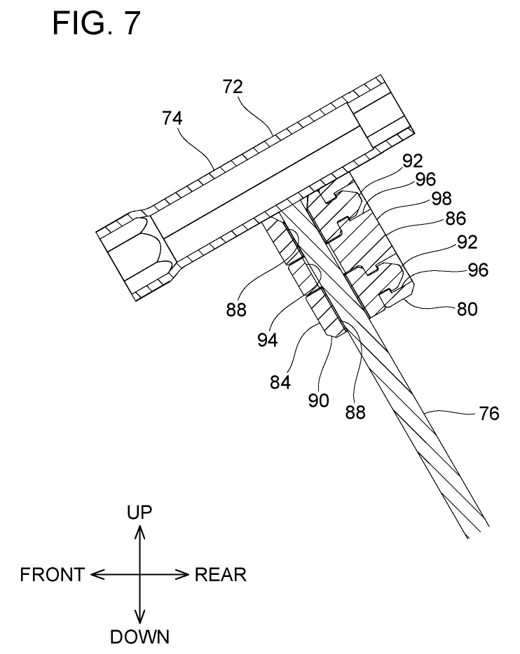

As shown in FIG. 7, the first retaining portion 84 comprises a first retaining hole 88 through which the rod portion 76 of the tool 72 is inserted, a first retaining portion body 90 defining the first retaining hole 88, and two snap projections 92 protruding from the rear surface of the first retaining portion body 90. The second retaining portion 86 comprises a second retaining hole 94 through which the rod portion 76 of the tool 72 is inserted, two snap holes 96 into which the two snap projections 92 snap fit, and a second retaining portion body 98 defining the second retaining hole 94 and the two snap holes 96. The retainer 80 is attached to the right fixed portion 46 by snap-fitting the two snap projections 92 into the two snap holes 96 with the band portion 82 (see FIG. 6) wrapped around the right fixed portion 46 (see FIG. 6). In this state, the retainer 80 can hold the tool 72 by receiving the rod portion 76 of the tool 72 into each of the first and second retaining holes 88 and 94. The retainer 80 is removed from the right fixed portion 46 by pulling the two snap projections 92 out of the two snap holes 96. However, in the state where the rod portion 76 of the tool 72 is inserted into each of the first retaining hole 88 and the second retaining hole 94, since the first retaining portion 84 and the second retaining portion 86 are secured to each other via the rod portion 76, pulling out the two snap projections 92 from the two snap holes 96 (i.e., removing the retainer 80 from the right fixed portion 46) is prohibited. In the state where the rod portion 76 is retracted from each of the first and second retaining holes 88 and 94, it is allowed to retract the two snap projections 92 from the two snap holes 96 (i.e., to remove the retainer 80 from the right fixed portion 46).

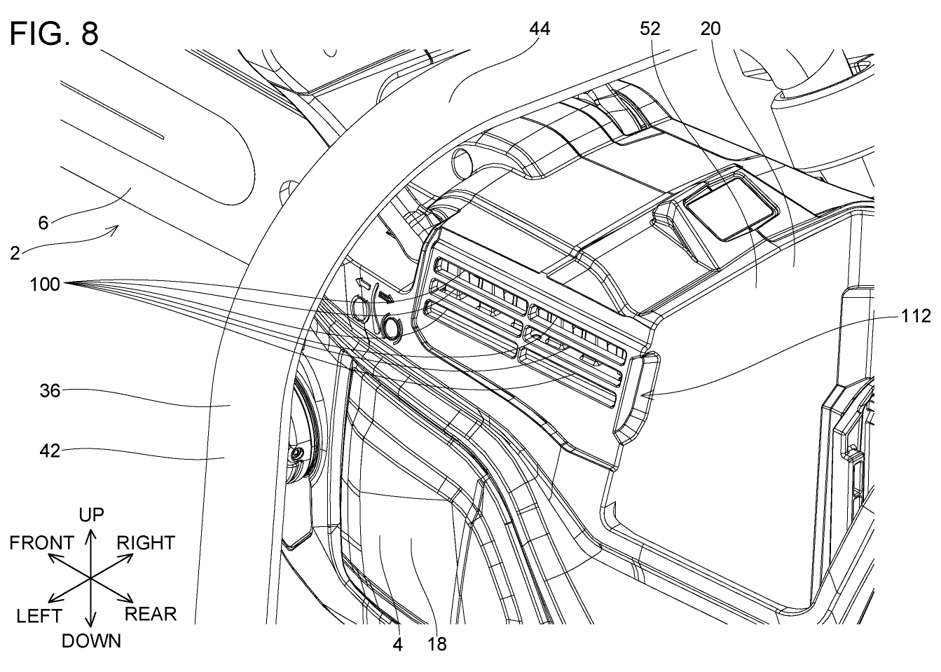

As shown in FIG. 8, a plurality of inlets 100 is defined in an upper part of the left surface of the housing 4 communicating the interior and the exterior of the housing 4 with each other. The plurality of inlets 100 is located frontward of the battery housing portion 20. Each of the plurality of inlets 100 is a long hole extending in the front-rear direction.

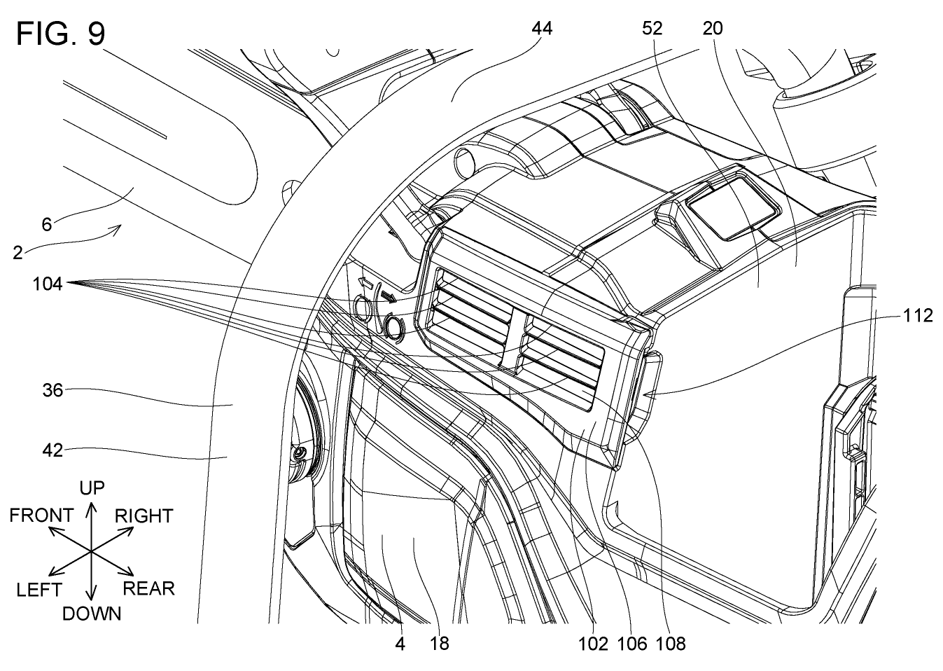

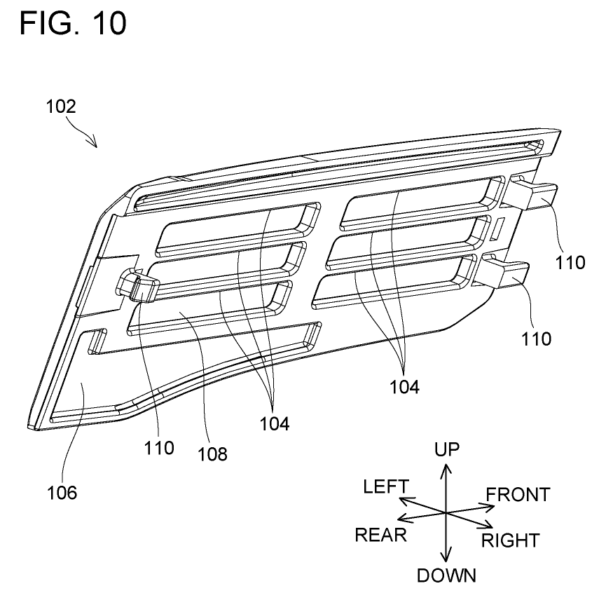

As shown in FIG. 9, the chainsaw 2 further comprises a filter 102 configured to be detachably attached to the housing 4 to cover the plurality of inlets 100 (see FIG. 8) from outside the housing 4. As shown in FIG. 10, the filter 102 comprises a filter plate 106 having a plurality of filter holes 104, a filter net 108 stretched over the plurality of filter holes 104, and a plurality of snap pawls 110 protruding from the right surface of the filter plate 106. The filter 102 is attached to the housing 4 by snap-fitting the plurality of snap pawls 110 to the periphery of the plurality of inlets 100 (see FIG. 8). Each of the plurality of filter holes 104 is positioned so as to face corresponding one of the plurality of inlets 100. The filter 102 allows air to enter the interior from the exterior of the housing 4 through the plurality of inlets 100, while suppressing foreign object(s) (e.g., cutting debris, dust) from entering the interior from the exterior of the housing 4 through the plurality of inlets 100.

As shown in FIG. 9, the housing 4 comprises a finger entry recess 112 at the rear side of the plurality of inlets 100. The finger entry recess 112 is open to the rear side. The user can disengage the plurality of snap pawls 110 (see FIG. 10) from the plurality of inlets 100 (see FIG. 8) by placing a finger in the finger entry recess 112 and pulling to lift the rear end and its vicinity of the filter 102 attached to the housing 4 leftward. This allows the filter 102 to be removed from the housing 4. When the battery pack B is attached to the battery attaching portion 54, the finger entry recess 112 is covered to be hidden by the battery pack B. Therefore, when the battery pack B is attached to the battery attaching portion 54 (i.e., when the user is using the chainsaw 2), the user's finger(s) can be prevented from entering the finger entry recess 112, thereby preventing the filter 102 from being removed from the housing 4.

As shown in FIG. 11, a plurality of outlets 114 communicating the interior and exterior of the housing 4 is defined on a front part of the lower surface of the housing 4. Each of the plurality of outlets 114 is a long hole extending in the front-rear direction. The plurality of outlets 114 is located to the right of the right end of the lower fixed portion 40 of the front grip 36.

As shown in FIG. 3, the chainsaw 2 further comprises an electric motor 116, a motor case 118, a control device 120, the oil tank 122, and the oil pump 124. The electric motor 116 is located inside the housing 4 and frontward of the battery attaching portion 54. The motor case 118 is secured to the housing 4 by screws 126 and supports the electric motor 116 by surrounding the outer peripheral surface of the electric motor 116. The control device 120 is located inside the housing 4 and above the motor case 118 (i.e., the electric motor 116). The oil tank 122 is located inside the housing 4 and frontward of the motor case 118 (i.e., the electric motor 116). The oil pump 124 is secured to the left wall of the motor case 118 by screws 128.

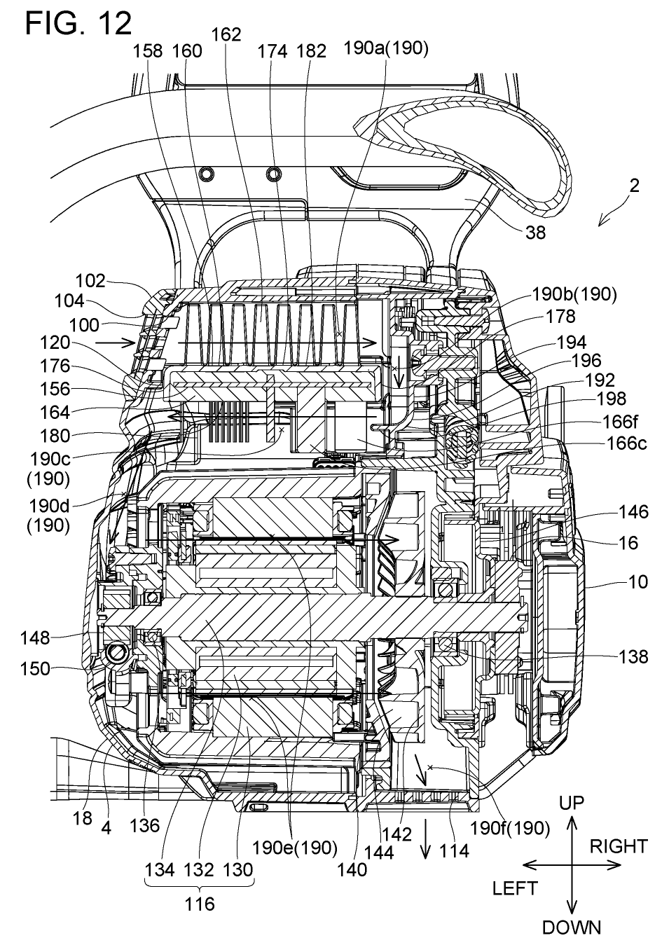

As shown in FIG. 12, the electric motor 116 in this embodiment is an inner rotor DC brushless motor with a stator 130, a rotor 132 located inside the stator 130, and an output shaft 134 fixed to the rotor 132. The output shaft 134 is rotatably supported by the housing 4 via bearings 136 and 138. A centrifugal fan 140, a brake drum 146, and the sprocket 16 are fixed to a right part of the output shaft 134. The centrifugal fan 140 is disposed to the right of the stator 130 and rotor 132. The brake drum 146 is disposed to the right of the centrifugal fan 140. The sprocket 16 is disposed to the right of the brake drum 146. As mentioned above, the saw chain 8 (see FIG. 1) extends from the guide bar 6 (see FIG. 1) and is wrapped around the sprocket 16. When the electric motor 116 operates, the sprocket 16 rotates with the output shaft 134, which drives the saw chain 8 along the perimeter of the guide bar 6. When the user tilts down the front hand guard 38 frontward while the output shaft 134 is rotating, the rotation of the output shaft 134 is braked via the brake drum 146. The centrifugal fan 140 rotates with the output shaft 134 to generate cooling air inside the housing 4. The centrifugal fan 140 comprises a disk portion 142 that extends in the radial direction of the output shaft 134 and a plurality of blades 144 protruding leftward from the left surface of the disk portion 142.

A worm gear 148 is fixed to the left portion of the output shaft 134. The worm gear 148 meshes with a worm wheel 150 of the oil pump 124 (see FIG. 3). Thus, when the electric motor 116 operates and the output shaft 134 rotates, the oil pump 124 is driven. When the oil pump 124 shown in FIG. 3 is driven, the lubricating oil stored in the oil tank 122 is suctioned into the oil pump 124 via a suction pipe 152 and discharged to the guide bar 6 and saw chain 8 through a discharge pipe 154.

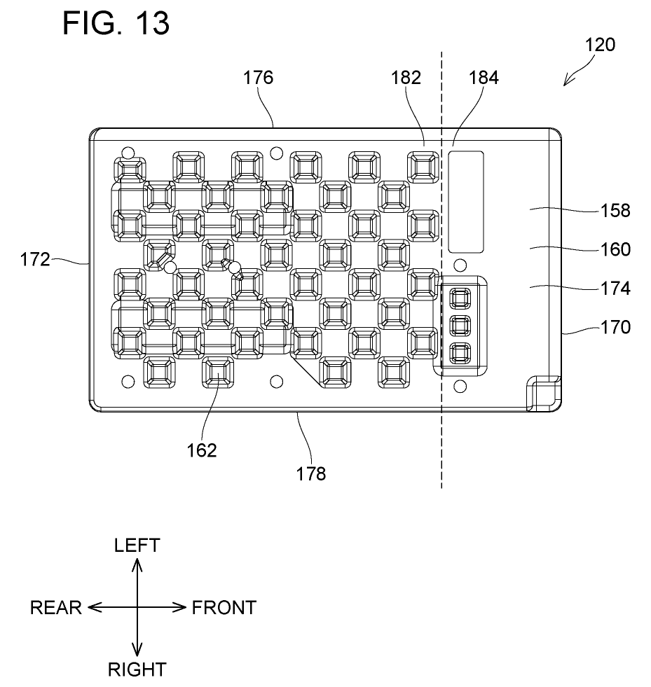

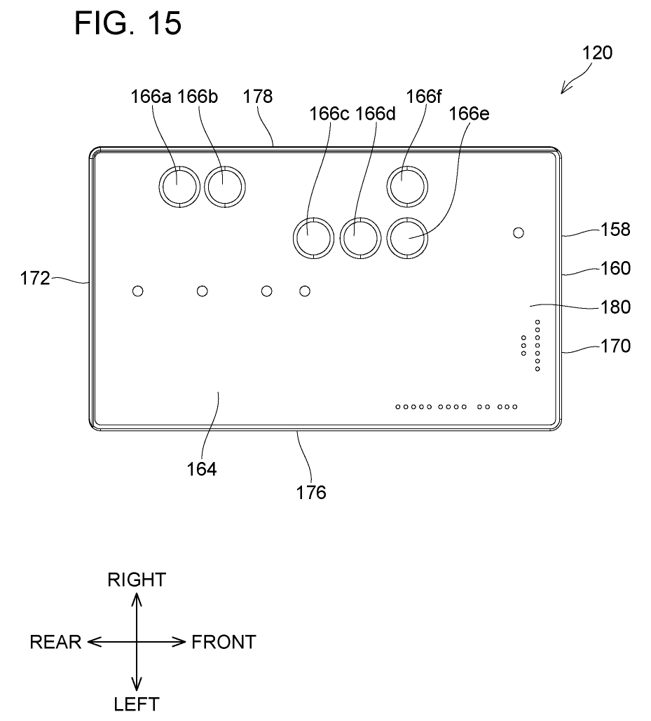

As shown in FIG. 12, the control device 120 comprises a control board 156 and a controller case 158 that houses the control board 156. The control board 156 contains an inverter circuit (not shown) with a plurality of switching elements and a control circuit (not shown) configured to control operation of each switching element. The controller case 158 is constituted of aluminum alloy, for example. The controller case 158 comprises a case body 160 that opens downward and a plurality of fins 162 protruding upward from an upper surface 174 of the case body 160. The control board 156 is secured to the case body 160 by screws (not shown). The control board 156 is sealed by potting resin 164 filled inside the case body 160. A plurality of capacitors 166a, 166b, 166c, 166d, 166e, and 166f (see FIG. 15) is disposed on the lower surface of the control board 156. The plurality of capacitors 166a, 166b, 166c, 166d, 166e, and 166f each protrudes downward from a lower surface 180 of the potting resin 164. The control device 120 has a substantially rectangular cuboid shape defined by a front surface 170 of the case body 160 (see FIG. 13), a rear surface 172 of the case body 160 (see FIG. 13), the upper surface 174 of the case body 160, a left surface 176 of the case body 160, a right surface 178 of the case body 160, and the lower surface 180 of the potting resin 164. The control device 120 is positioned so that the lower surface 180 of the potting resin 164 faces the upper surface of the motor case 118.

As shown in FIG. 13, the upper surface 174 of the case body 160 is arranged such that the longitudinal direction is along the front-rear direction and the short-side direction is along the left-right direction. The upper surface 174 of the case body 160 comprises a first area 182 in which the plurality of fins 162 is disposed and a second area 184 in which the plurality of fins 162 is not disposed. The first area 182 is disposed rearward of the second area 184. In FIG. 13, the boundary between the first area 182 and the second area 184 is illustrated by a dashed line.

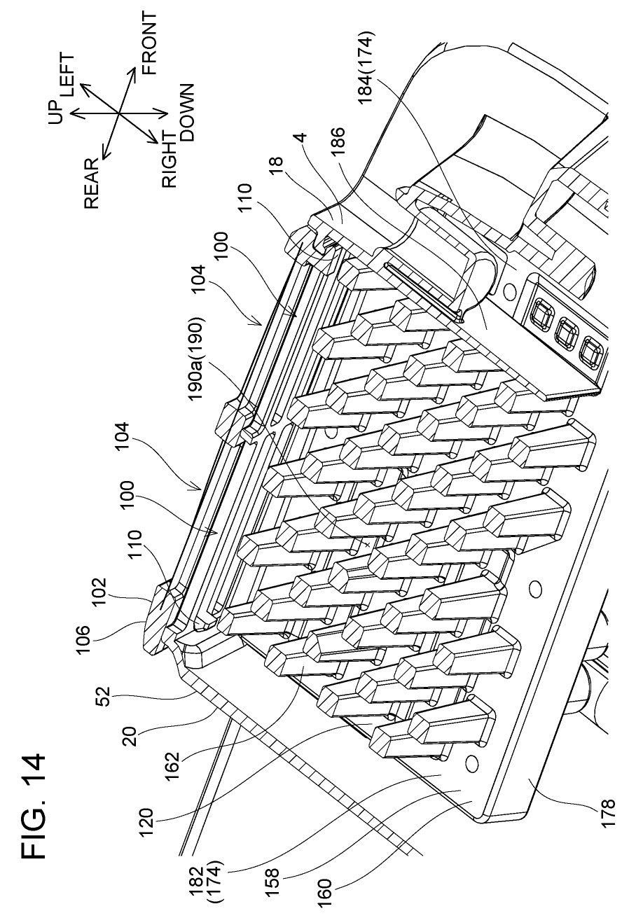

As shown in FIG. 14, a space facing the first area 182 (i.e., the space in which the plurality of fins 162 is arranged) is arranged to face the plurality of inlets 100. The housing 4 also comprises a partition wall 186 that partitions the space facing the first area 182 (i.e., the space in which the plurality of fins 162 is arranged) and a space facing the second area 184 (i.e., the space in which the plurality of fins 162 is not arranged) from each other. The partition wall 186 guides the cooling air, which flowed in through the plurality of inlets 100, to flow into the space facing the first area 182 (i.e., the space in which the plurality of fins 162 is arranged).

As shown in FIG. 15, the lower surface 180 of the potting resin 164 is arranged so that the longitudinal direction is along the front-rear direction and the short-side direction is along the left-right direction. The plurality of capacitors 166a, 166b, 166c, 166d, 166e, and 166f includes a first capacitor 166a positioned at the most rearward, a second capacitor 166b offset frontward from the first capacitor 166a, a third capacitor 166c offset to a front left direction from the second capacitor 166b, a fourth capacitor 166d offset frontward from the third capacitor 166c, a fifth capacitor 166e offset frontward from the fourth capacitor 166d, and a sixth capacitor 166f offset rightward from the fifth capacitor 166e. As described in detail below, cooling air flows from right to left near the lower surface 180 of the potting resin 164 (see FIG. 12). Since the plurality of capacitors 166a, 166b, 166c, 166d, 166e, and 166f is dispersed in the front-rear direction (i.e., perpendicular to the direction in which cooling air flows), the cooling air is evenly blown onto the outer surfaces of the plurality of capacitors 166a, 166b, 166c, 166d, 166e, and 166f.

### Cooling Air Passage 190

As shown in FIG. 12, a cooling air passage 190 configured to send air, which flowed in through the plurality of inlets 100, to the plurality of outlets 114 is defined in the housing 4. The cooling air passage 190 comprises an upper passage portion 190a facing the first area 182 of the upper surface 174 of the case body 160, a right passage portion 190b facing the right surface 178 of the case body 160, a central passage portion 190c facing the lower surface 180 of the potting resin 164 and facing the upper surface of the motor case 118, a left passage portion 190d which runs through a space between the left wall of the motor case 118 and the left wall of the housing 4, a lower passage portion 190e which runs through the interior space of the motor case 118 (specifically, space between the stator 130 and the rotor 132), and a volute passage portion 190f which houses the centrifugal fan 140. The upper passage portion 190a extends rightward from the inlets 100. The right passage portion 190b extends downward from the right end of the upper passage portion 190a. The central passage portion 190c extends leftward from the lower end of the right passage portion 190b. The left passage portion 190d extends downward from the left end of the central passage portion 190c. The lower passage portion 190e extends rightward from the lower end of the left passage portion 190d. The volute passage portion 190f connects to the right end of the lower passage portion 190e, and the volute passage portion 190f opens to the outlets 114. Thus, the cooling air passage 190 is a passage including the upper passage portion 190a, the right passage portion 190b, the central passage portion 190c, the left passage portion 190d, the lower passage portion 190e, and the volute passage portion 190f that are connected in series. Therefore, when cooling air flows in the cooling air passage 190, the flow rate of cooling air in each of the upper passage portion 190a, the right passage portion 190b, the central passage portion 190c, the left passage portion 190d, the lower passage portion 190e, and the volute passage portion 190f is substantially equal.

When the electric motor 116 operates and the centrifugal fan 140 rotates with the output shaft 134, air (i.e., cooling air) flows into the inlets 100 from outside the housing 4. The cooling air, which flowed in through the inlets 100, flows through the upper passage portion 190a, the right passage portion 190b, the central passage portion 190c, the left passage portion 190d, the lower passage portion 190e, and the volute passage portion 190f in this order, and is discharged from the outlets 114 to the outside of the housing 4. The cooling air dissipates heat from the upper surface 174 and the plurality of fins 162 of the case body 160 as it flows through the upper passage portion 190a, dissipates heat from the right surface 178 of the case body 160 as it flows through the right passage portion 190b, dissipates heat from the lower surface 180 of the potting resin 164 and the plurality of capacitors 166a, 166b, 166c, 166d, 166e, and 166f as it flows through the central passage portion 190c, dissipates heat from the electric motor 116 as it flows through the lower passage portion 190e, and is finally discharged to the outside of the housing 4. This cools the control device 120 and the electric motor 116. In FIG. 12, the flow of cooling air is illustrated with arrows.

The upper passage portion 190a extends from the left end of the upper surface 174 of the case body 160 along the upper surface 174 of the case body 160 to the right end of the upper surface 174 of the case body 160. The central passage portion 190c extends from the right end of the lower surface 180 of the potting resin 164 along the lower surface 180 of the potting resin 164 to the left end of the lower surface 180 of the potting resin 164. These allow for a larger contact area between the control device 120 and the cooling air, allowing the cooling air to dissipate a larger quantity of heat from the control device 120.

The housing 4 comprises a guide wall 192 that guides the cooling air at a connection between the lower end of the right passage portion 190b (i.e., the downstream end of the right passage portion 190b) and the right end of the central passage portion 190c (i.e., the upstream end of the central passage portion 190c). The guide wall 192 comprises a first flat wall 194 facing a lower part of the right surface 178 of the case body 160, a curved wall 196 curving from the lower end of the first flat wall 194 to extend leftward, and a second flat wall 198 extending leftward from the left end of the curved wall 196. The second flat wall 198 extends along the lower surface 180 of the potting resin 164. The guide wall 192 allows cooling air flowing from the right passage portion 190b into the central passage portion 190c to be guided to flow along the lower surface 180 of the potting resin 164.

### Depth Limiter 200

As shown in FIG. 1, the chainsaw 2 further comprises a depth limiter 200. The depth limiter 200 is configured to be attached to the guide bar 6 to limit the depth of insertion of the guide bar 6 into a cutting target (e.g., window glass, steel plate, roof, door, etc.). With the depth limiter 200 attached to the guide bar 6, the front end of the depth limiter 200 contacts the cutting target when inserting the tip of the guide bar 6 into the cutting target, by which the guide bar 6 can be suppressed from being inserted further into the cutting target. The depth limiter 200 is attached to the guide bar 6 by being engaged with one of a plurality of bar through-holes 202 defined in the guide bar 6. The plurality of bar through-holes 202 is aligned along the longitudinal direction of the guide bar 6. The user can change the position of the depth limiter 200 relative to the guide bar 6 by changing the bar through-hole 202 to which the depth limiter 200 is attached, thereby adjusting an allowable insertion depth.

The depth limiter 200 comprises a first component 204 positioned to the left of the guide bar 6 and a second component 250 positioned to the right of the guide bar 6.

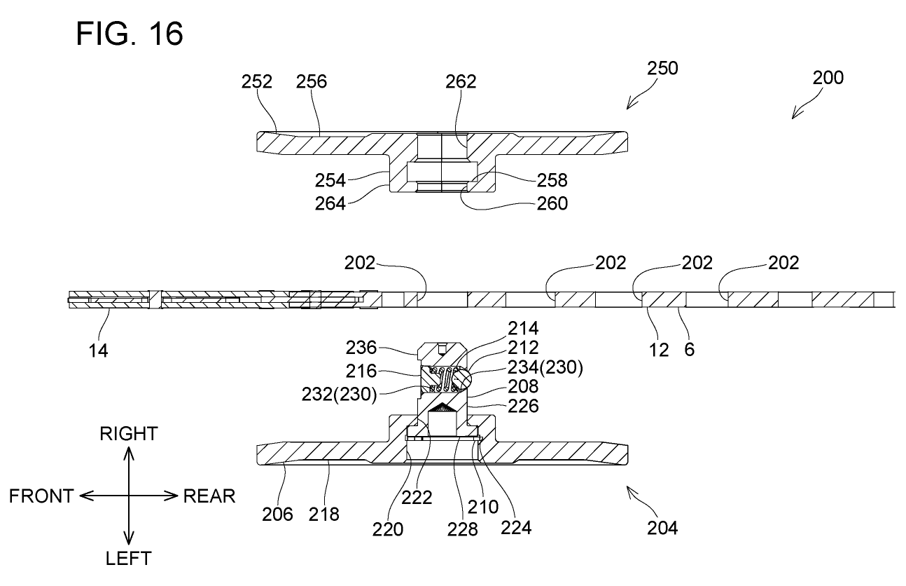

As shown in FIG. 16, the first component 204 comprises a first plate member 206, a shaft member 208, a retaining ring 210, a ball 212, a spring 214, and a spring receiving member 216. The first plate member 206 comprises a first plate body 218 having a disc shape, a recess 220 defined by recessing the center portion of the first plate body 218 rightward, an axial hole 222 extending through the bottom wall of the recess 220, and a first circumferential groove 224 defined in the side wall of the recess 220. The first plate body 218 is disposed along the left surface of the guide bar 6. The shaft member 208 comprises an axial body 226 extending in the left-right direction and a head 228 extending radially outward from the left end of the axial body 226. The axial body 226 is inserted into the axial hole 222 of the first plate member 206 and projects rightward from the first plate member 206. The retaining ring 210 is fitted into the first circumferential groove 224 of the first plate member 206. The head 228 of the shaft member 208 is sandwiched between the bottom surface of the recess 220 and the right surface of the retaining ring 210. This secures the shaft member 208 to the first plate body 218. The shaft member 208 also has a ball housing hole 230 that extends through the axial body 226 in the front-rear direction. The ball housing hole 230 comprises a guide portion 232 having an inner diameter slightly larger than the outer diameter of the ball 212 and a stopper portion 234 having an inner diameter slightly smaller than the outer diameter of the ball 212. The guide portion 232 is disposed at a front part of the ball housing hole 230. The stopper portion 234 is disposed at a rear part of the ball housing hole 230. The spring receiving member 216 is press-fitted into the front opening of the ball housing hole 230. The ball 212 is disposed between the spring receiving member 216 and the stopper portion 234. The spring 214 biases the ball 212 rearward against the spring receiving member 216. Normally, the ball 212 is retained by the biasing force of the spring 214 in a position where it projects into the exterior space of the axial body 226 through the rear opening of the ball housing hole 230 (i.e., in a projecting position projecting outward from the outer circumferential surface of the axial body 226). Hereinafter, a component including the axial body 226, the ball housing hole 230, the ball 212, the spring 214, and the spring receiving member 216 will also be referred to as “protruding engagement portion 236.”

The second component 250 comprises a second plate member 252. The second plate member 252 comprises a cylindrical portion 254 through which the shaft member 208 of the first component 204 can be inserted, a second plate body 256 having a disc shape that extends radially outward from the right end of the cylindrical portion 254, a second circumferential groove 258 defined on the inner circumferential surface of the cylindrical portion 254, a left-side through-hole 260 that is defined by the inner circumferential surface of the cylindrical portion 254 on the left side of the second circumferential groove 258, and a right-side through-hole 262 defined by the inner circumferential surface of the cylindrical portion 254 on the right side of the second circumferential groove 258. The second circumferential groove 258 is recessed radially outward from the inner circumferential surface of the cylindrical portion 254. Due to this, the inner diameter of the second circumferential groove 258 is larger than the inner diameter of the cylindrical portion 254 (i.e., the inner diameters of the left-side through-hole 260 and the right-side through-hole 262). Hereinafter, a component including the cylindrical portion 254, the second circumferential groove 258, the left-side through-hole 260, and the right-side through-hole 262 will also be referred to as “recessed engagement portion 264”.

First, a procedure for attaching the first component 204 and the second component 250 to the guide bar 6 will be described.

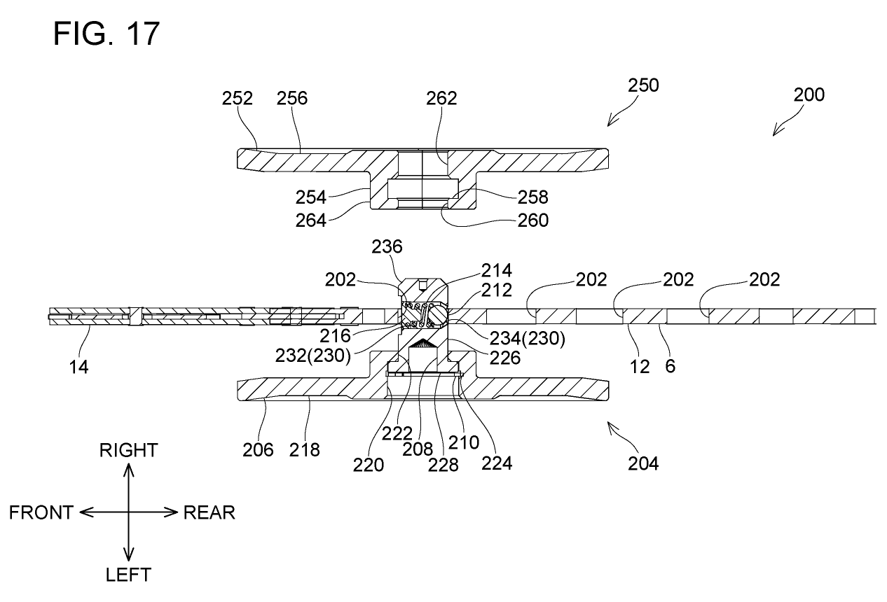

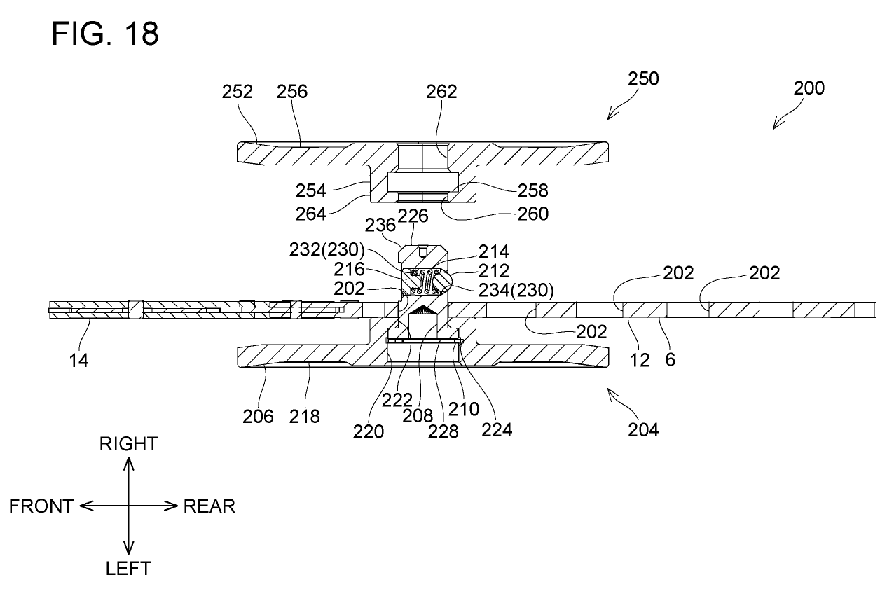

As shown in FIG. 17, when the protruding engagement portion 236 of the first component 204 is inserted into the bar through-hole 202 of the guide bar 6, the peripheral edge of the bar through-hole 202 abuts the outer surface of the ball 212 in the projecting position. Due to this, the ball 212 is pushed into a retracted position, which is more retracted inside the ball housing hole 230 than the projecting position. Thereafter, when the protruding engagement portion 236 is further inserted relative to the bar through-hole 202, the peripheral edge of the bar through-hole 202 rides over the ball 212. Once the peripheral edge of the bar through-hole 202 has ridden over the ball 212, the ball 212 returns to the projecting position by the biasing force of the spring 214. As shown in FIG. 18, the protruding engagement portion 236 engages the bar through-hole 202, thereby attaching the first component 204 to the guide bar 6. In this state, when the protruding engagement portion 236 attempts to slip out of the bar through-hole 202, the peripheral edge of the bar through-hole 202 abuts the outer surface of the ball 212 in the projecting position. In other words, the ball 212 in the projecting position interferes with the bar through-hole 202. This prevents the protruding engagement portion 236 from slipping out of the bar through-hole 202. By moving the second component 250 in a direction approaching the guide bar 6 with the first component 204 attached to the guide bar 6, the protruding engagement portion 236 of the first component 204 can be inserted into the recessed engagement portion 264 of the second component 250.

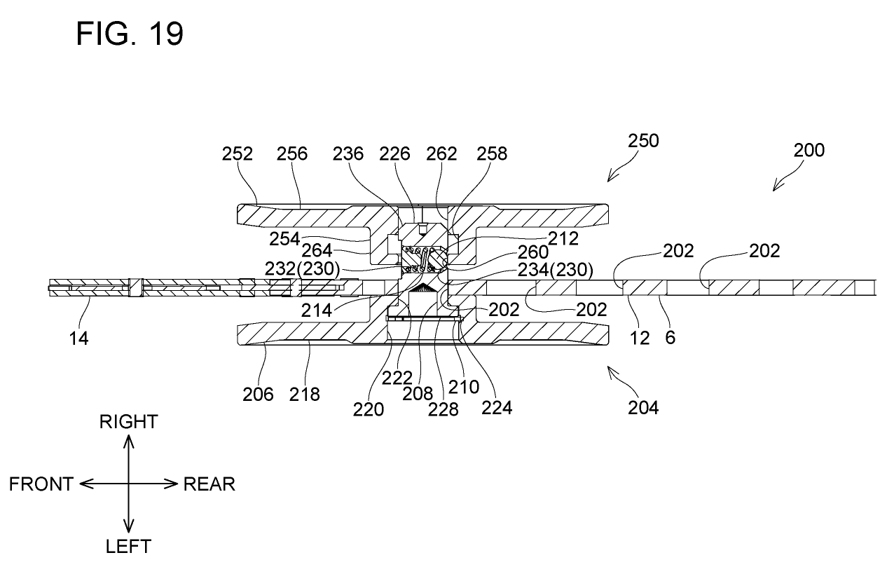

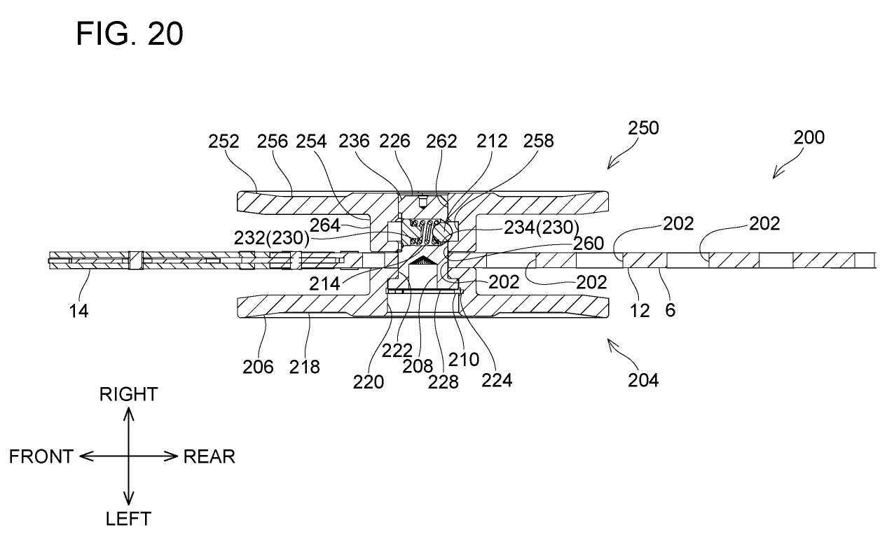

As shown in FIG. 19, when the protruding engagement portion 236 of the first component 204 is inserted into the recessed engagement portion 264 of the second component 250, the peripheral edge of the left-side through-hole 260 abuts the outer surface of the ball 212 in the projecting position. This pushes the ball 212 into the retracted position. Then, when the protruding engagement portion 236 is further inserted into the left-side through-hole 260, the peripheral edge of the left-side through-hole 260 rides over the ball 212 and the ball 212 reaches the second circumferential groove 258. The bottom surface of the second circumferential groove 258 does not interfere with the ball 212 in the projecting position. Due to this, when the ball 212 reaches the second circumferential groove 258, the ball 212 returns to the projecting position by the biasing force of the spring 214. As shown in FIG. 20, the protruding engagement portion 236 engages the left-side through-hole 260, the first component 204 and the second component 250 are attached to each other, and the second component 250 is attached to the guide bar 6. In this state, when the protruding engagement portion 236 attempts to slip out of the left-side through-hole 260, the peripheral edge of the left-side through-hole 260 abuts the outer surface of the ball 212 in the projecting position. In other words, the ball 212 in the projecting position interferes with the left-side through-hole 260. This prevents the protruding engagement portion 236 from slipping out of the left-side through-hole 260. With the protruding engagement portion 236 engaged with the left-side through-hole 260, the axial body 226 of the protruding engagement portion 236 fits into each of the left-side through-hole 260 and the right-side through-hole 262 of the recessed engagement portion 264. This prevents the first component 204 and the second component 250 from being loose relative to each other.

Next, a procedure for removing the first component 204 and the second component 250 from the guide bar 6 will be described.

From the state shown in FIG. 20, by moving the second component 250 in a direction separating away from the guide bar 6, the protruding engagement portion 236 moves by slipping out of each of the left-side through-hole 260 and right-side through-hole 262. At this time, as shown in FIG. 19, the peripheral edge of the left-side through-hole 260 abuts the outer surface of the ball 212 in the projecting position. Due to this, the ball 212 is pushed into the retracted position and the engagement between the protruding engagement portion 236 and the left-side through-hole 260 is disengaged. Thereafter, when the protruding engagement portion 236 is further extracted from the left-side through-hole 260, the peripheral edge of the left-side through-hole 260 rides over the ball 212. Once the peripheral edge of the left-side through-hole 260 has ridden over the ball 212, the ball 212 returns to the projecting position by the biasing force of the spring 214. As shown in FIG. 18, the second component 250 is then removed from the first component 204 and removed from the guide bar 6.

By moving the first component 204 in the direction separating away from the guide bar 6 from the state shown in FIG. 18, the protruding engagement portion 236 moves by slipping out of the bar through-hole 202. At this time, as shown in FIG. 17, the peripheral edge of the bar through-hole 202 abuts the outer surface of the ball 212 in the projecting position. Due to this, the ball 212 is pushed into the retracted position and the engagement between the protruding engagement portion 236 and the bar through-hole 202 is disengaged. Thereafter, when the protruding engagement portion 236 is further extracted from the bar through-hole 202, the peripheral edge of the bar through-hole 202 rides over the ball 212. Once the peripheral edge of the bar through-hole 202 has ridden over the ball 212, the ball 212 returns to the projecting position by the biasing force of the spring 214. This causes the first component 204 to be removed from the guide bar 6, as shown in FIG. 16.

Although not shown in the figures, the surface of the first plate member 206 of the first component 204 is bare. Therefore, the surface of the first plate member 206 is silver-white. On the other hand, the surface of the second plate member 252 of the second component 250 is anodized. Due to the anodizing, the surface of the second plate member 252 is colored red. This allows the user to identify differences between the first component 204 and the second component 250 (e.g., differences in uneven shapes) by color.

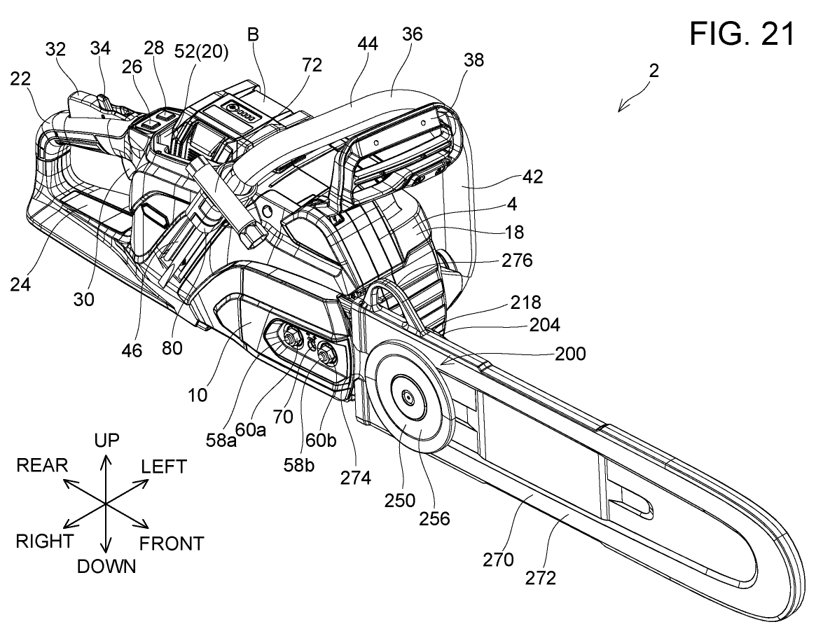

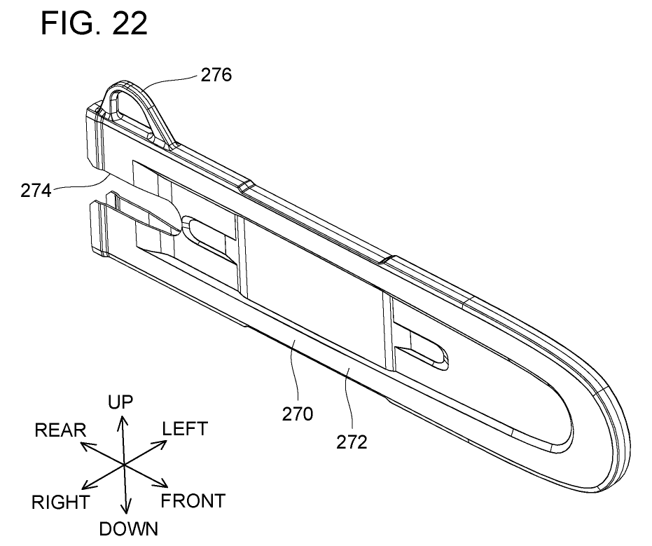

As shown in FIG. 21, the chainsaw 2 further comprises a cover 270 that is detachably attached to the guide bar 6. As shown in FIG. 22, the cover 270 comprises a cover body 272 that opens rearward, a notch 274 defined in a rear side part of the cover body 272, and a carabiner portion 276 defined above the rear part of the cover body 272. As shown in FIG. 21, the cover body 272 accommodates the guide bar 6. The notch 274 extends frontward from the rear end of cover body 272. The notch 274 exposes the rearmost bar through-hole 202 of the plurality of bar through-holes 202 (see FIG. 1) to the outside. The notch 274 can suppress the depth limiter 200 attached to the rearmost bar through-hole 202 and the cover 270, which is attached to and detached from the guide bar 6, from interfering with each other. Due to this, the user can attach and detach the cover 270 to and from the guide bar 6 with the depth limiter 200 remaining attached to the guide bar 6. Even with the cover 270 attached to the guide bar 6, the user can still see the depth limiter 200 attached to the guide bar 6. This can suppress the user from forgetting to take the depth limiter 200 to a work site. The user can also suppress the cover 270 from unintentionally coming off the guide bar 6 by putting a string through the carabiner portion 276 and tying that string to the front grip 36, for example.

### Variants

See FIG. 12 The shape and layout of the cooling air passage 190, the control device 120, and the electric motor 116 may be applied to working machines other than the chainsaw 2 (e.g., hedge trimmer, electric circular saw, lawn mower).

See FIG. 12 The centrifugal fan 140 may be replaced by another form of fan (e.g., an axial flow fan). The centrifugal fan 140 is not limited to the one which rotates integrally with the output shaft 134, but may also rotate independently of the output shaft 134. In this case, the chainsaw 2 may comprise an electric motor configured to rotate the centrifugal fan 140 separately from the electric motor 116.

See FIG. 12 The cooling air passage 190 may face any front or rear surface of the control device 120. For example, the cooling air passage 190 may face the front surface 170 and rear surface 172 of the case body 160. Alternatively, the cooling air passage 190 may face the left surface 176 and the right surface 178 of the case body 160.

See FIG. 12 The cooling air passage 190 may not comprise a portion that passes through the electric motor 116 (i.e., the lower passage portion 190e). In this case, the cooling air, which flowed in through the inlets 100, may pass through the front and rear surfaces of the control device 120 and then to the outlets 114 without passing through the electric motor 116.

See FIG. 12 The chainsaw 2 may not comprise the motor case 118. Due to this, the outer surface of the stator 130 may be exposed to the central passage portion 190c of the cooling air passage 190.

See FIGS. 3 and 12 The control device 120 may be offset from the position shown in the embodiment in the front-rear or left-right direction. Due to this, the lower surface 180 of the potting resin 164 may not face the upper surface of the motor case 118.

See FIG. 12 The cooling air passage 190 may not have a portion facing the right surface 178 of the case body 160 (i.e., the right passage portion 190b). In this case, the cooling air, which flowed in through the inlets 100, may flow along the upper surface 174 of the case body 160 and then along the lower surface 180 of the potting resin 164 without flowing along the right surface 178 of the case body 160.

See FIG. 12 The control device 120 may be arranged in an upside-down orientation from the orientation shown in the embodiment. Thereby, the plurality of capacitors 166a, 166b, 166c, 166d, 166e, and 166f may be arranged in the upper passage portion 190a and the plurality of fins 162 may be arranged in the central passage portion 190c.

See FIG. 12 The control device 120 may not comprise the plurality of fins 162.

See FIG. 14 The housing 4 may not comprise the partition wall 186. Due to this, the upper passage portion 190a may face each of the first area 182 and second area 184 of the upper surface 174 of the case body 160.

See FIG. 15 The control device 120 may not comprise at least one of the plurality of capacitors 166a, 166b, 166c, 166d, 166e, and 166f.

See FIG. 15 The plurality of capacitors 166a, 166b, 166c, 166d, 166e, and 166f may be aligned in the front-rear direction (i.e., perpendicular to the direction in which cooling air flows).

See FIG. 12 The guide wall 192 may not comprise the second flat wall 198.

See FIG. 12 The upper passage portion 190a may extend along a part of the upper surface 174 of the case body 160 from the left end to the right end. The central passage portion 190c may extend along a part of the lower surface 180 of the potting resin 164 from the right end to the left end.

See FIG. 12 The upper passage portion 190a may not face the inlets 100.

See FIGS. 12, 13 The upper passage portion 190a may extend along the longitudinal (i.e., front-rear) direction of the upper surface 174 of the case body 160.

See FIGS. 12, 15 The central passage portion 190c may extend along the longitudinal direction (i.e., front-rear direction) of the lower surface 180 of the potting resin 164.

See FIG. 10 The chainsaw 2 may not comprise the filter 102.

See FIGS. 16 to 20 The positions of the first component 204 and the second component 250 relative to the guide bar 6 may be interchanged. That is, the first component 204 may be disposed on the right surface of the guide bar 6 and the second component 250 may be disposed on the left surface of the guide bar 6.

See FIG. 1 The first plate body 218 and/or the second plate body 256 may have a shape other than a disc shape (e.g., a polygonal shape).

See FIG. 3 The chainsaw 2 may comprise a prime mover (e.g., an internal combustion engine) other than the electric motor 116, and the sprocket 16 may be rotated by the prime mover.

See FIGS. 16 to 20 The hole diameter of each of the bar through-hole 202 may be large enough that the peripheral edge of the bar through-hole 202 does not interfere with the ball 212 when the protruding engagement portion 236 is being inserted into the bar through-hole 202. Due to this, the protruding engagement portion 236 and the bar through-hole 202 may be configured not to engage each other.

See FIGS. 16 to 20 Instead of comprising the ball housing hole 230, the ball 212, the spring 214, and the spring receiving member 216, the protruding engagement portion 236 may comprise an O-ring attached to the outer circumferential surface of the axial body 226. In this example, when the protruding engagement portion 236 is being inserted into the bar through-hole 202 (or left-side through-hole 260), the peripheral edge of the bar through-hole 202 (or left-side through-hole 260) may press against the O-ring to ride over the O-ring so that the protruding engagement portion 236 engages the bar through-hole 202 (or left-side through-hole 260). When the protruding engagement portion 236 is slipping out of the bar through-hole 202 (or left-side through-hole 260), the peripheral edge of the bar through-hole 202 (or left-side through-hole 260) may press against the O-ring to ride over the O-ring so that the engagement between the protruding engagement portion 236 and the bar through-hole 202 (or left-side through-hole 260) is disengaged.

See FIGS. 16 to 20 Instead of comprising the ball housing hole 230, the ball 212, the spring 214, and the spring receiving member 216, the protruding engagement portion 236 may have a male thread defined on the outer circumferential surface of the axial body 226. Instead of comprising the second circumferential groove 258, the recessed engagement portion 264 may comprise a female thread defined on the inner circumferential surface of the cylindrical portion 254. In this example, the protruding engagement portion 236 and the recessed engagement portion 264 may be engaged with each other by screwing the male thread of the protruding engagement portion 236 into the female thread of the recessed engagement portion 264. The male thread of the protruding engagement portion 236 may be fixed in position on the first plate member 206 or may be rotatable relative to the first plate member 206.

See FIGS. 16 to 20 The surface of the first plate member 206 and the surface of the second plate member 252 may have a same surface treatment. Due to this, the color of the surface of the first plate member 206 and the color of the surface of the second plate member 252 may be the same color.

See FIG. 21 The chainsaw 2 may not comprise the cover 270.

See FIGS. 1 and 2 The guide bar 6 may not comprise the tip sprocket 14 (i.e., the portion where high-strength metal is used).

See FIGS. 1 and 2 The chainsaw 2 may not comprise the depth limiter 200. In this case, the guide bar 6 may not comprise the bar through-holes 202.

### Features of Embodiments

In one or more embodiments, the chainsaw 2 (example of a working machine) comprises: the saw chain 8 (example of a working part); the electric motor 116 configured to drive the saw chain 8; the control device 120 configured to control the electric motor 116; the housing 4 that houses the electric motor 116 and the control device 120; the inlets 100 and the outlets 114 that communicate the interior and the exterior of the housing 4; the cooling air passage 190 defined in the interior of the housing 4 and configured to send air, which flowed in through the inlets 100, toward the outlets 114; and the centrifugal fan 140 (example of a fan) configured to generate cooling air which flows from the inlets 100 through the cooling air passage 190 to the outlets 114. The control device 120 comprises the upper surface 174 (example of a first surface) and the lower surface 180 (example of a second surface) in a front-and-back relationship with each other. The cooling air passage 190 comprises the upper passage portion 190a (example of a first passage portion) facing the upper surface 174 of the control device 120 and the central passage portion 190c (example of a second passage portion) facing the lower surface 180 of the control device 120. The upper passage portion 190a and the central passage portion 190c are connected in series with each other. The cooling air flows through the upper passage portion 190a and then the central passage portion 190c. The flow rate of the cooling air flowing through the upper passage portion 190a and the flow rate of the cooling air flowing through the central passage portion 190c are substantially equal to each other.

According to the above configuration, since the upper passage portion 190a and the central passage portion 190c are connected in series with each other, the flow rate of the cooling air flowing through the upper passage portion 190a (i.e., the first flow rate) and the flow rate of the cooling air flowing through the central passage portion 190c (i.e., the second flow rate) are substantially equal. Therefore, since the first flow rate and the second flow rate are not in a trade-off relationship, both the first flow rate and the second flow rate can be increased. This allows the control device 120 to be sufficiently cooled.

In one or more embodiments, the cooling air passage 190 further comprises the lower passage portion 190e (example of a third passage portion) passing through the interior of the electric motor 116. The cooling air flows through the upper passage portion 190a, the central passage portion 190c, and then the lower passage portion 190e.

According to the above configuration, the cooling air can cool not only the control device 120 but also the electric motor 116.

In one or more embodiments, the chainsaw 2 further comprises the motor case 118 surrounding the outer peripheral surface of the electric motor 116. The control device 120 is disposed such that the lower surface 180 faces the motor case 118.

According to the above configuration, the central passage portion 190c facing the lower surface 180 of the control device 120 and the lower passage portion 190e passing through the interior of the electric motor 116 are located close to each other. This shortens the cooling air passage 190 and reduces the pressure loss generated when the cooling air flows in the cooling air passage 190. As a result, it can be suppressed that the pressure loss causes the flow rate of the cooling air to decrease.

In one or more embodiments, the control device 120 comprises the fins 162 protruding from the upper surface 174 (an example of one of the first surface and the second surface).

According to the above configuration, the presence of the fins 162 can increase a contact area between the control device 120 and the cooling air. This allows the control device 120 to be cooled efficiently.

In one or more embodiments, the upper surface 174 comprises the first area 182 in which the fins 162 are disposed and the second area 184 in which the fins 162 are not disposed. The housing 4 comprises the partition wall 186 partitioning the first area 182 and the second area 184 from each other.

The first area 182 in which the fins 162 are disposed has a higher heat dissipation efficiency than the second area 184 in which the fins 162 are not disposed. According to the above configuration, the partition wall 186 can suppress the cooling air from flowing into the second area 184 (i.e., the area with a relatively low heat dissipation efficiency) and promote the cooling air to flow into the first area 182 (i.e., the area with a relatively high heat dissipation efficiency). This allows a larger flow rate of the cooling air through the first area 182 (i.e., the area with the relatively high heat dissipation efficiency), thus the control device 120 can be cooled more efficiently.

In one or more embodiments, the control device 120 further comprises the capacitors 166a, 166b, 166c, 166d, 166e, and 166f protruding from the lower surface 180 (examples of the other of the first surface and the second surface).

According to the above configuration, the cooling air flows so that the cooling air is blown onto the outer surfaces of the capacitors 166a, 166b, 166c, 166d, 166e, and 166f. This allows direct cooling of the capacitors 166a, 166b, 166c, 166d, 166e, and 166f.

In one or more embodiments, the capacitors 166a, 166b, 166c, 166d, 166e, and 166f comprise the first capacitor 166a and the second capacitor 166b. The first capacitor 166a and the second capacitor 166b are offset from each other in a direction along the lower surface 180 and perpendicular to the direction in which the cooling air flows.

If the first capacitor 166a and the second capacitor 166b are aligned along the direction in which the cooling air flows, the capacitor located upstream of the first capacitor 166a and the second capacitor 166b may become an obstacle and the cooling air may not be blown onto the downstream one of the first capacitor 166a and the second capacitor 166b. As a result, only one of the first capacitor 166a and the second capacitor 166b may be cooled, and the other of the first capacitor 166a and the second capacitor 166b may not be cooled. In contrast, according to the above configuration, the first capacitor 166a and the second capacitor 166b are aligned in a direction perpendicular to the direction in which the cooling air flows, so the cooling air is blown onto both the first capacitor 166a and the second capacitor 166b. As a result, both the first capacitor 166a and the second capacitor 166b can be cooled.

In one or more embodiments, the cooling air passage 190 comprises the right passage portion 190b (example of an intermediate passage portion) facing the right surface 178 (example of an end surface) which connects the upper surface 174 and lower surface 180 of the control device 120. The cooling air flows through the upper passage portion 190a, the right passage portion 190b, and then the central passage portion 190c.

According to the above configuration, the cooling air flows along three surfaces of the control device 120 (i.e., the upper surface 174, the lower surface 180, and the right surface 178). This allows the control device 120 to be cooled efficiently.

In one or more embodiments, the housing 4 comprises the second flat wall 198 (an example of a flat wall) disposed at the connection between the downstream end of the right passage portion 190b and the upstream end of the central passage portion 190c, wherein the second flat wall 198 extends along the lower surface 180.

According to the above configuration, the second flat wall 198 can be used to guide the cooling air flowing from the right passage portion 190b into the central passage portion 190c to flow along the lower surface 180 of the control device 120. This allows the control device 120 to be cooled efficiently.

In one or more embodiments, the upper passage portion 190a extends from one end of the upper surface 174 along the upper surface 174 to the other end of the upper surface 174. The central passage portion 190c extends from one end of the lower surface 180 along the lower surface 180 to the other end of the lower surface 180.

According to the above configuration, the cooling air flows from one end of the upper surface 174 along the upper surface 174 to the other end of the upper surface 174, and then from one end of the lower surface 180 along the lower surface 180 to the other end of the lower surface 180. This allows for a larger contact area between the control device 120 and the cooling air, thus the control device 120 can be cooled efficiently.

In one or more embodiments, the upper passage portion 190a faces the inlets 100.

The cooling air immediately after flowing into the inlets 100 has not yet absorbed any heat from components in the housing 4, and is at a relatively low temperature. According to the above configuration, the cooling air immediately after flowing into the inlets 100, i.e., the cooling air with the relatively low temperature, flows through the upper passage portion 190a. Therefore, the cooling air dissipates a large quantity of heat from the upper surface 174 of the control device 120. This allows the control device 120 to be cooled efficiently.

In one or more embodiments, the upper passage portion 190a extends along the short-side direction of the upper surface 174 of the control device 120. The central passage portion 190c extends along the short-side direction of the lower surface 180 of the control device 120.

According to the above configuration, the upper passage portion 190a is shorter as compared to a configuration in which the upper passage portion 190a extends along a longitudinal direction of the upper surface 174 of the control device 120. Furthermore, according to the above configuration, the central passage portion 190c is shorter as compared to a configuration in which the central passage portion 190c extends along a longitudinal direction of the lower surface 180 of the control device 120. These shorten the cooling air passage 190, thereby reducing the pressure loss generated when the cooling air flows in the cooling air passage 190. As a result, the pressure loss can be suppressed from causing a decrease in the flow rate of the cooling air.

In one or more embodiments, the chainsaw 2 further comprises the filter 102 configured to be detachably attached to the housing 4 to cover the inlets 100 from the exterior of the housing 4.

According to the above configuration, it is possible to suppress foreign object(s) (e.g., cutting debris) from entering the interior of the housing 4 from the exterior through the inlets 100. Furthermore, according to the above configuration, the user can remove the filter 102 from the housing 4 and clean the filter 102.

What is claimed is:

1. A working machine comprising:
a working part;
an electric motor configured to drive the working part;
a control device configured to control the electric motor;
a housing that houses the electric motor and the control device;
an inlet communicating an interior and an exterior of the housing with each other;
an outlet communicating the interior and the exterior of the housing with each other;
a cooling air passage defined in the interior of the housing and configured to send air, which flowed in through the inlet, toward the outlet; and
a fan configured to generate cooling air which flows from the inlet through the cooling air passage to the outlet,
wherein
the control device comprises a first surface and a second surface that are in a front-and-back relationship with each other,
the cooling air passage comprises a first passage portion facing the first surface of the control device and a second passage portion facing the second surface of the control device,
the first passage portion and the second passage portion are connected in series with each other,
the cooling air flows through the first passage portion and then the second passage portion, and
a flow rate of the cooling air flowing through the first passage portion and a flow rate of the cooling air flowing through the second passage portion are substantially equal to each other.

2. The working machine according to claim 1, wherein the cooling air passage further comprises a third passage portion passing through an interior of the electric motor, and
the cooling air flows through the first passage portion, the second passage portion, and then the third passage portion.

3. The working machine according to claim 2, further comprising a motor case surrounding an outer peripheral surface of the electric motor,
wherein
the control device is disposed such that the second surface faces the motor case.

4. The working machine according to claim 1, wherein the control device comprises a fin protruding from one of the first surface and the second surface.

5. The working machine according to claim 4, wherein the one of the first surface and the second surface comprises a first area in which the fin is disposed and a second area in which the fin is not disposed, and
the housing comprises a partition wall partitioning the first area and the second area from each other.

6. The working machine according to claim 4, wherein the control device further comprises a capacitor protruding from the other of the first surface and the second surface.

7. The working machine according to claim 6, wherein the capacitor comprises a first capacitor and a second capacitor, and
the first capacitor and the second capacitor are offset from each other in a direction extending along the other of the first surface and the second surface and perpendicular to a direction in which the cooling air flows.

8. The working machine according to claim 1, wherein the cooling air passage comprises an intermediate passage portion facing an end surface of the control device which connects the first surface and the second surface, and
the cooling air flows through the first passage portion, the intermediate passage portion, and then the second passage portion.

9. The working machine according to claim 8, wherein the housing comprises a flat wall disposed at a connection portion between a downstream end of the intermediate passage portion and an upstream end of the second passage portion, wherein the flat wall extends along the second surface.

10. The working machine according to claim 1, wherein the first passage portion extends from one end of the first surface along the first surface to another end of the first surface, and
the second passage portion extends from one end of the second surface along the second surface to another end of the second surface.

11. The working machine according to claim 1, wherein the first passage portion faces the inlet.

12. The working machine according to claim 1, wherein the first passage portion extends along a short-side direction of the first surface of the control device, and
the second passage portion extends along a short-side direction of the second surface of the control device.

13. The working machine according to claim 1, further comprising a filter configured to be detachably attached to the housing so as to cover the inlet from the exterior of the housing.

14. The working machine according to claim 3, wherein the control device comprises a fin protruding from one of the first surface and the second surface,
the one of the first surface and the second surface comprises a first area in which the fin is disposed and a second area in which the fin is not disposed,
the housing comprises a partition wall partitioning the first area and the second area from each other,
the control device further comprises a capacitor protruding from the other of the first surface and the second surface,
the capacitor comprises a first capacitor and a second capacitor,
the first capacitor and the second capacitor are offset from each other in a direction extending along the other of the first surface and the second surface and perpendicular to a direction in which the cooling air flows,
the cooling air passage comprises an intermediate passage portion facing an end surface of the control device which connects the first surface and the second surface,
the cooling air flows through the first passage portion, the intermediate passage portion, and then the second passage portion,
the housing comprises a flat wall disposed at a connection portion between a downstream end of the intermediate passage portion and an upstream end of the second passage portion, wherein the flat wall extends along the second surface,
the first passage portion extends from one end of the first surface along the first surface to another end of the first surface,
the second passage portion extends from one end of the second surface along the second surface to another end of the second surface,
the first passage portion faces the inlet,
the first passage portion extends along a short-side direction of the first surface of the control device,
the second passage portion extends along a short-side direction of the second surface of the control device, and
the working machine further comprises a filter configured to be detachably attached to the housing so as to cover the inlet from the exterior of the housing.
